(19) United States
(12) Patent Application Publication
(10) Pub. No.: US 2012/0133100 A1
(43) Pub. Date: May 31, 2012

(54) COMPRESSION UNIT

(76) Inventor: Azhar Bin ZAINAL ABIDIN, Taman Setiawangsa (MY)

(21) Appl. No.: 13/304,023

(22) Filed: Nov. 23, 2011

(30) Foreign Application Priority Data
Nov. 25, 2010 (MY) PI 2010005567

(51) Int. Cl. F16J 15/34

(52) U.S. Cl. 277/379

(57) ABSTRACT

A compression unit (108) for a mechanical seal, comprising a hollow cylinder (112) having a first end (317), a second end (321), a seal face (111) attached to the second end (321), and a resilient region (210) between the first end (317) and the second end (321), characterized in that the resilient region (210) is defined by a plurality of helical slots (201) passing completely through the cylinder's (112) wall, each of the slots (201) having a distinct starting (206) and end point (207) such that the slots (201) co-axially coiled around the cylinder (112) and the starting (206) and end point (207) for each helical slot (201) are spaced around the periphery of the cylinder (112).

### FIELD OF INVENTION

The present invention relates to a compression unit within the mechanical seal. More particularly, the compression unit is an improved design which comprises a one-piece resilient means, acting as a loading, device for the seal faces.

### BACKGROUND OF THE INVENTION

Mechanical seals are commonly used in various type of fluid handling equipments as means for controlling leakages. Most fluid handling equipments such as pumps, have a rotating shaft and a fluid chamber. One of the seal faces is mounted on the shaft thus it is rotating with the shaft, while the other seal face is static, mounted on the seal housing and hence the seal prevent leakage between the rotating shaft and the housing.

Within the mechanical seal is a compression unit, which functions as a loading device for the seal faces. When there is no hydraulic pressure built up from the process fluid, the compression unit imparts an axial load to the seal face and maintain the contact between the rotating face and the stationary face. The axial load from the compression unit also assists in providing seal face pressure when operating at low pressure conditions or when the seal is subjected to vacuum.

Conventionally, mechanical seal compression unit consists of spring holder, washer, spring and seal face. The spring holder is a housing used to hold and prevent the spring from bending when the spring is being compressed. Besides, the spring holder also act as a holder for the seal face to transmit rotational torque from the shaft to the seal face. This allows the movement of the seal face in axial direction when the spring is being compressed. On the other hand, washer is used for positioning and centering the spring, and also aiding the concentricity between the spring and the shaft. This combination is disclosed in U.S. Pat. No. 2009/029,5097.

There are some compression units which use a single coil spring instead of multiple springs. The main problem faced in this combination is having a non-uniform spring force on the seal face. When the seal face is pressed, the force is applied to compress the spring and for single coil spring, the force will act at one particular point instead of being distributed uniformly on the seal face area. This causes non-uniform face wear and increase seal face waviness.

Another disadvantage of having a single coil spring is the unwanted lateral deflections, called the buckling effect. Buckling in single coil spring occurs during compression of the spring, when the middle part of the spring deformed in a non-axial direction. This occurs because there is no middle support, causing the middle part of the single coil spring to freely move when the force is applied. As the coil spring buckle, the intended force cannot be provided and the off-axis deformation continues until the spring fails.

By introducing multiple springs design, the non-uniform spring force problem can be solved. With this design, multiple springs are arranged at equal space around the periphery to give multiple support points, thus distributing the spring force evenly on the seal face. However, this design introduced more components to the compression unit, causing debris or dirt particles to deposit easily on the spring surface. This condition occurs due to a stagnant flow inside the small spring hole and debris are not easily flushed out from the spring area, thus preventing the spring from being compressed.

U.S. Pat. No. 2007/210,526 and U.S. Pat. No. 6,962,339 disclose another type of mechanical seal assembly which includes a welded metal bellow. This design eliminates the drawbacks of the single and multiple spring and has a wider range of operating temperature. Metal bellows required complicated manufacturing process as they are made through a process of stamping disc-like plate in specific contoured shapes and welding them in pairs at the inside diameter to form individual convolution of the bellows. A series of convolution is then stacked together and welded at the outside diameter to form the bellows. This requires a series of stamping and welding, thus increasing manufacturing cost. Another problem in operating mechanical seals with metal bellows is the vibration in the bellow itself. This occurs due to lack of damping elements at the seal face free end, causing easy movements in radial direction when the pump rotates.

Accordingly, it is desirable for the present invention to provide an improved compression unit which can overcome the drawbacks of the prior arts. The invention shall also provide flexible features which helps to enhance usability in the application of a mechanical seal.

### SUMMARY OF INVENTION

Accordingly, it is a primary object of the present invention to provide an improved compression unit developed from a combination of sealing technology and advanced machined spring in a single piece unit to reduce the complexity of the conventional designs which have multiple parts.

It is another object of the present invention to provide an improved compression unit which is capable of imparting an uniform pressure to the seal face and able to compress without buckling.

It is yet another object of the present invention to provide an improved compression unit which has free residual stress in its application compared to coiled spring.

It is further another object of the present invention to provide an improved compression unit which has the flexibility to be integrated with various applications through the exchangeable adapters to suit different pumping devices.

Yet another object of the present invention is to provide an improved compression unit attainable through simple manufacturing process to reduce the manufacturing cost.

Further embodiment of the present invention is to provide an improved compression unit having simplicity and user-friendly features to ease maintenance process.

At least one of the preceding objects is met, in whole or in part, by the present invention, in which one of the embodiments of the present invention describes a compression unit (108) for a mechanical seal, comprising a hollow cylinder (112) having a first end (317), a second end (321), a seal face (111) attached to the second end (321), and a resilient region (210) between the first end (317) and the second end (321), characterized in that the resilient region (210) is defined by a plurality of helical slots (201) passing completely through the cylinder's (112) wall, each of the slots (201) having a distinct starting (206) and end point (207) such that the slots (201) co-axially coiled around the cylinder (112) and the starting (206) and end point (207) for each helical slot (201) are spaced around the periphery of the cylinder (112).

The present preferred embodiments of the invention consists of novel features and a combination of parts hereinafter fully described and illustrated in the accompanying drawings and particularly pointed out in the appended claims; it being understood that various changes in the details may be effected by those skilled in the arts but without departing from the scope of the invention or sacrificing any of the advantages of the present invention.

### BRIEF DESCRIPTION OF THE DRAWINGS

These and other features, aspects and advantages of the present invention will be more fully understood when considered with respect to the following detailed descriptions, appended claims and accompanying drawings wherein:

FIG. 1 shows the compression unit's embodiments in a mechanical seal.

FIG. 2 shows the anisometric view of the compression unit.

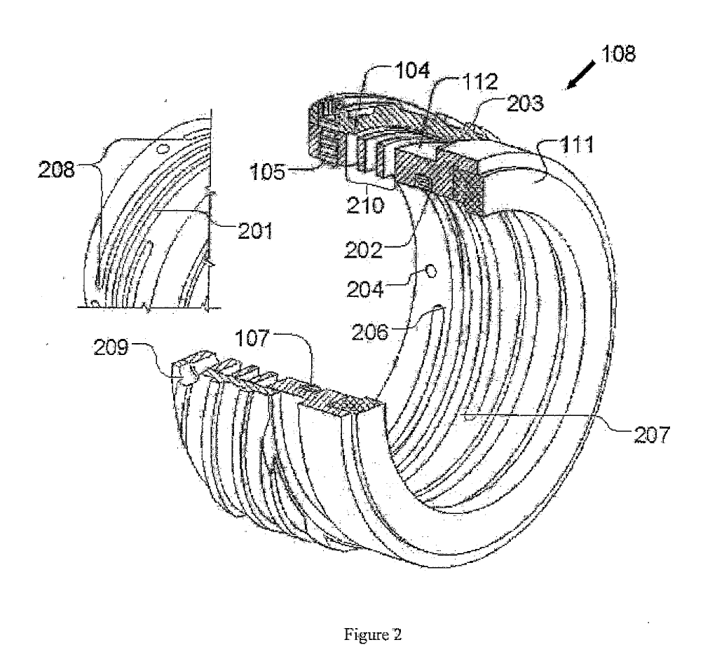

FIG. 3 shows the detailed cross section of the compression unit.

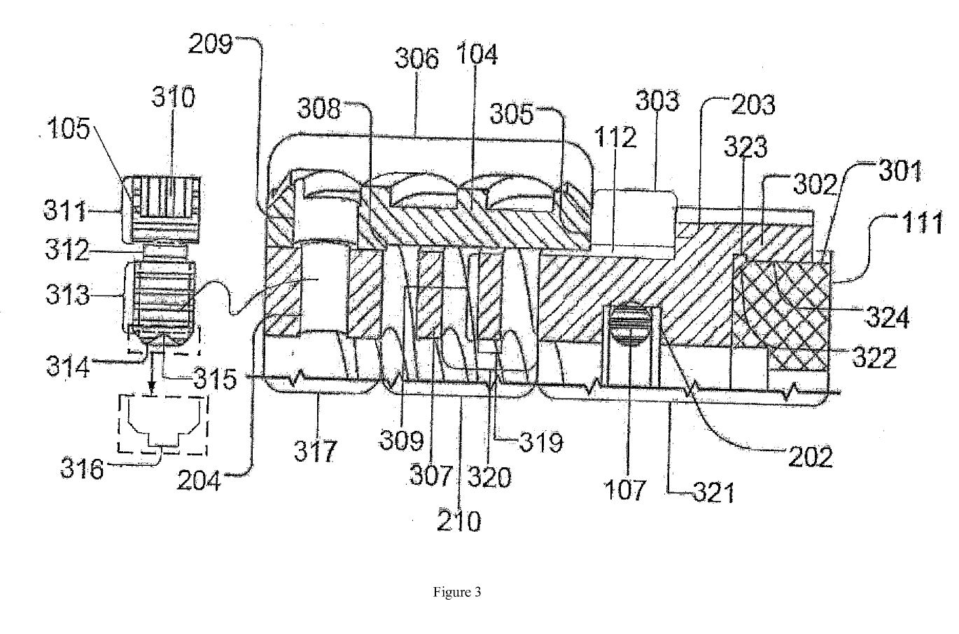

### DETAILED DESCRIPTION OF THE INVENTION

The present invention relates to a compression unit within a mechanical seal. More particularly, the compression unit is an improved design which incorporates sealing technology and machined spring technique resulting in a single unit resilient means, acting as a loading device for the seal faces. The compression unit imparts an axial load to the seal face to maintain surface contact prior to pump operations.

Hereinafter, the invention shall be described according to the preferred embodiments of the present invention and by referring to the accompanying description and drawings. However, it is to be understood that limiting the description to the preferred embodiments of the invention and to the drawings is merely to facilitate discussion of the present invention and it is envisioned that those skilled in the art may devise various modifications without departing from the scope of the appended claim.

The present invention discloses a compression unit (108) for a mechanical seal, comprising a hollow cylinder (112) having a first end (317), a second end (321), a seal face (111) attached to the second end (321), and a resilient region (210) between the first end (317) and the second end (321), characterized in that the resilient region (210) is defined by a plurality of helical slots (201) passing completely through the cylinder's (112) wall, each of the slots (201) having a distinct starting (206) and end point (207) such that the slots (201) co-axially coiled around the cylinder (112) and the starting (206) and end point (207) for each helical slot (201) are spaced around the periphery of the cylinder (112). The helical slots (201) also have rectangular cross sections.

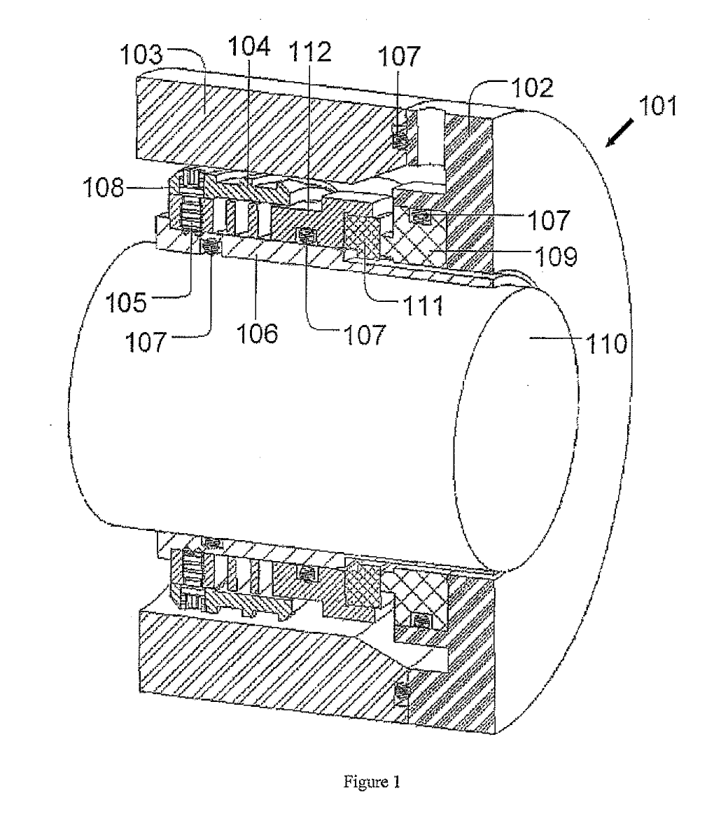

The single piece compression unit (108) has non-homogeneous parts, comprising the resilient region (210) and the seal face (111). For the mechanical seal to function, the compression unit (108) is attached to either shaft sleeve (106) or mechanical seal gland (102) depending on the seal arrangements used in a dynamic or static compression unit. As shown in FIG. 1, for a dynamic seal arrangement, the single piece compression unit (108) rotates accordingly with the shaft (110) and the shaft sleeve (106). The resilient region (210) imparts a force to press against a rotating seal face (111) to the static seal face (109) prior to pump operations.

In one of the preferred embodiment, the compression unit (108) has a shape of a hollow cylinder (112) to accommodate the shaft sleeve (106). The inside diameter of the hollow cylinder (112) is designed accordingly to the seal size which ranges from 20 mm to 200 mm. The resilient region (210) spans between the first end (317) and the second end (321), comprises of numerous continuous helical slots (201), which have a distinct starting point (206) and end point (207). The resilient region (210) forms a helical flexure on the compression unit (108). This feature is an improved design compared to a normal coil spring, as it is machined from a single piece of material, making it possible for a single solid part to have a flexible spring region. The hollow cylinder (112) can be made of metals which has high modulus of elasticity and tensile strength such as stainless steel and titanium. The material selection also depends on the application, for example for a corrosion-prone environment, the more suitable material will be duplex (two phase micro-structure) stainless steel or titanium.

Conventionally, wire wound spring compression unit uses single coil springs. However, the helical flexure in the improved compression unit (108) can have more than one coil. The numerous continuous helical slots (201) intertwined around the hollow cylinder (112) to form a multiple start flexure (208). This feature can provide a balance force and gives a uniform load distribution to the compression unit (108). When the resilient region (210) is being compressed, the force is acting along the cylinder (112) mean center line, where the distance between the center line provides a moment arm to the resilient region (210). This internal moment is canceled off and resolved within the compression unit (108) in a multiple start flexure (208), making the resilient region (210) compressed in a straight manner without buckling. By having a multiple start flexure (208), the deflection of the resilient region (210) will be uniform and thus giving a uniform pressure to the seal face (111). In incidence where a helical slot (201) gives way, the failed part will be physically trapped by the remaining coils, preventing it to damage the other parts of the mechanical seal.

The helical slots (201) have a rectangular cross section (307) and it is machined precisely to give a specific thickness (309) and pitch (320). For all different seal size, precise machining gives the ability for the designer to come out with different configurations to maintain required spring force. A rectangular cross section (307) has additional flexibility compared to normal coiled spring as the thickness (309) and width (319) can be manipulated instead of just the spring diameter. Ratio of the thickness (309) over mean diameter is preferably kept above 6.5 to reduce stress factor and the width (319) is preferred to be kept above 2.5 mm to prevent significant bending stress in the resilient region (210).

Another preferred embodiment of the present invention discloses that the compression unit's (108) second end (321) is relatively longer than the first end (317) to accommodate an O-ring (107) used as a secondary sealing element in the mechanical seal. The second end (321) further comprises a housing (302) to hold the seal face. The seal face is then attached to the cylinder (112) through shrink-fit method.

As shown in the figures, the longer second end (321) provides a groove (202) to accommodate an O-ring (107) as stated above. For the O-ring (107) to work as a secondary sealing element, the groove (202) is preferably designed accordingly to the O-ring size, keeping in mind to allow 15% to 20% O-ring (107) compression. This groove (202) also should be machined precisely, with surface finish up to 3 μm surface roughness to allow the O-ring (107) to work well.

Another feature embodied on the second end (321) is the housing (302) to hold the seal face (111) in place. The housing (302) is preferred to have a small groove (323) to remove a round corner left by a noose radius of the cutting tool during manufacturing process. With that feature, there will be no interference between the seal face (111) sharp edge and the housing (302) during shrink-fit process. This is essential to give a uniform surface contact between seal face (111) and the hollow cylinder (112). The second end (321) also has a step (203) preferably making the second end's (321) diameter bigger than the first end (317), as a holding, space for a weighted jig to press the hollow cylinder (112) together with the shrink-fitted seal face (111) against a flat surface during lapping process. This process is can be considered as a surface treatment process, giving a seal face (111) flatness up to 1 helium light band (0.3 μm surface flatness).

The seal face (111) can be made from silicon carbide, tungsten carbide, carbon or any other seal face material. Preferably, the seal face (111) has a cylindrical ring shape and to have a outer diameter bigger than the housing (302) inner diameter (324). This can give an adequate tolerance for the shrink-fitting which is based on the seal operating temperature and strength of the seal face (111) material. For example, when the mechanical seal operates above 250° C., considered to be high temperature operating condition, the hollow cylinder (112) metal body expand more compare to the ceramic or composite seal face (111), causing the connection to loosen and the seal face (111) to slip into housing (302), resulting in a leakage. Another feature on the seal face is a chamfer (322), serves to remove the sharp edges to prevent interference during shrink-fit process.

The compression unit (108) incorporates shrink-fit method to hold the seal face (111) together with the hollow cylinder (112). With shrink-fitting, the seal face (111) and the cylinder (112) will be substantially bonded with an excellent surface contact. Shrink-fit method uses material thermal expansion to give an adequate interference between the seal face (111) and driver, this making these two parts to contact appropriately and bonded together as a single part. This approach increases heat removal capability by allowing heat conduction from the seal face to the driver and further on to the surrounding through convection and thus, reducing the overall seal face (111) temperature and extending its life span.

In a preferred embodiment, the compression unit (108) comprises an exchangeable adapters (104) to suit various force circulation applications. The compression unit (108) can operate with or without the exchangeable adapters (104). For a specific application, a different type and specifications of exchangeable adapters (104) can be used with the compression unit (108). Preferably, the exchangeable adapters (104) is slot on top of the hollow cylinder (112) and fixed at the first end (317) of the cylinder (112). This arrangement hides the appearance of the resilient region (210), and the compression unit (108) is able to be compressed inside the exchangeable adapters (104). To prevent surface contact between the hollow cylinder (112) and the adapters (104), a small step (308) made on the inside diameter of the adapters (104) is preferred. This can give a minimum radial clearance of 1.0 mm between the two parts mentioned above. The length of the adapters (104) is also designed to have a minimum clearance (303) of 5 mm between the step (203) on the second end (321) and its free end (305) to avoid interference when the resilient region (210) is being compressed to its working length. The adapters (104) is used with the compression unit (108) to introduce force circulation flow, increase overall heat convection and further increase heat removal capability.

In another preferred embodiment, the first end (317) of the compression unit (108) further comprises a plurality of threaded holes (204) to accommodate a clamping means (105), which is used to secure the compression unit (108) together with the exchangeable adapters (104) to a shaft (110). The clamping means (105) has a threaded end (313) and a top portion (311), where the threaded end (313) has a cone feature to hold the shaft (110) and the top portion (311) being formed to allow tightening of the clamping means (105).

A unique set screw which serves a purpose as clamping means (105) to hold the hollow cylinder (112) and the exchangeable adapters (104) to the shaft (110). Preferably, the top portion (311) has a hexagon shape hole (310) which is compatible with the alien key, used for tightening the set screw. The top portion (311) size is designed to fit inside the non-threaded hole (209) on the exchangeable adapters (104). A small groove (312) is present, separating the top portion (311) and the threaded end (313). The threaded end (313) holds and clamps the hollow cylinder (112) to the shaft sleeve (106) to transmit rotational torque from the shaft (110) to the compression unit (108). Preferably, at the end of the threaded section, there is a cone feature (315) with a sharp edge (314) for the screw to hold the shaft for clamping purposes. This feature can also be replaced with a dog-point feature (316), with a hole provided on the shaft sleeve (106).

In addition to that, the size of the threaded holes (204) on the first end (317), vary from M5 to M10 thread specifications, depending on the seal size and required clamping force. A bigger seal size may require more clamping force, resulting in a bigger screw to be fixed onto the compression unit (108). The threaded holes (204) accommodate the clamping means (105) accordingly. A combination of threaded size and the quantity of screws give a design flexibility to provide the requires clamping force to attached the hollow cylinder (112) to the shaft sleeve (106) as explained earlier.

The invention possesses a high product value as it has the capability to reduce the complexity of the conventional compression units with its single piece helical flexure and has the versatility to be able to use in different seal applications. Furthermore, the improved compression unit is able to give a uniform pressure on the seal face. The simple design and user-friendly features also eased the maintenance processes for mechanical seals.

Although this disclosure has described and illustrated certain preferred embodiments of the invention, it is to be understood that the invention is not restricted to those particular embodiments. Rather, the invention include all embodiments which are functional or mechanical equivalence of the specific embodiments and features that have been described and illustrated.

1. A compression unit (108) for a mechanical seal, comprising:
a hollow cylinder (112) having a first end (317), a second end (321), a seal face (111) attached to the second end (321), and a resilient region (210) between the first end (317) and the second end (321),
characterized in that the resilient region (210) is defined by a plurality of helical slots (201) passing completely through the cylinder's wall, each of the slots (201) having a distinct starting (206) and end point (207) such that the slots (201) co-axially coiled around the cylinder (112) and the starting (206) and end point (207) for each helical slot (201) are spaced around the periphery of the cylinder (112).

2. A compression unit (108) according to claim 1 wherein the second end (321) is relatively longer than the first end (317) to accommodate an O-ring (107) used as a secondary sealing element in the mechanical seal.

3. A compression unit (108) according to claim 1 wherein the second end (321) further comprises a housing (302) to hold the seal face.

4. A compression unit (108) according to claim 1 wherein the seal face is attached to the hollow cylinder (112) through shrink-fit method.

5. A compression unit (108) according to claim 1 wherein the helical slots (201) have rectangular cross sections.

6. A compression unit (108) according to claim 1 further comprising an exchangeable adapters (104) to suit various force circulation applications.

7. A compression unit according to claim 1 wherein the first end (317) further comprises a plurality of threaded holes (204) to accommodate a clamping means (105), which is used to secure the compression unit (108) together with the exchangeable adapters (104) to a shaft (110).

8. A compression unit (108) according to claim 7 wherein the clamping means (105) further comprises a threaded end (313) and a top portion (311): the threaded end (313) having a cone feature to hold the shaft (110) and the ton portion (311) being formed to allow tightening of the clamping means (105).
